(19) United States
(12) Patent Application Publication
(10) Pub. No.: US 2019/0166085 A1
(43) Pub. Date: May 30, 2019

(54) BLOCKCHAIN-BASED DOMAIN NAME RESOLUTION SYSTEM

(71) Applicant: PEKING UNIVERSITY SHENZHEN GRADUATE SCHOOL, Shenzhen (CN)

(72) Inventors: Hui LI, Shenzhen (CN); Huajun MA, Shenzhen (CN); Haopeng LI, Shenzhen (CN); Zhihao HUANG, Shenzhen (CN); Xin YANG, Shenzhen (CN); Kedan LI, Shenzhen (CN); Han WANG, Shenzhen (CN)

(73) Assignee: PEKING UNIVERSITY SHENZHEN GRADUATE SCHOOL, Shenzhen (CN)

(21) Appl. No.: 15/768,833

(22) PCT Filed: Apr. 19, 2017
(86) PCT No.: PCT/CN2017/081060

§ 371 Date: Apr. 16, 2018

(51) Int. Cl. H04L 29/12; H04L 9/06

(52) U.S. Cl. CPC H04L 61/103; H04L 61/1511; H04L 2209/38; H04L 61/6009; H04L 61/1535; H04L 9/0618

(57) ABSTRACT

The invention relates to a blockchain-based domain name resolution system, characterized in that the domain name resolution system adopts a layered structure comprising a top-level domain name chain network, a second-level domain name chain network, a future network node and an existing DNS system network; the top-level domain name chain network links the second-level domain name chain network, the future network node and the existing DNS system network respectively, and the top-level domain name chain network is used for each professional organization to deploy the server nodes having a reliable performance respectively to form a union blockchain network, wherein each node server records the information of all the current top-level domain names, the second-level domain name chain nodes, the future network nodes and the root nodes of the existing DNS system; the second-level domain name chain network is used for the registration and management of domain names, and recording of all the second-level domain names and their subdomain names; the future network node is used for the storage of the metadata and index in the future network. The invention reduces the resolution request, thus effectively improving the efficiency of domain name resolution.

### BACKGROUND OF THE INVENTION

### Technical Field

The invention belongs to the field of improved Internet technology, and more particularly, to a blockchain-based domain name resolution system and method.

### Description of Related Art

In 2008, Satoshi Nakamoto published a research report titled “Bitcoin: A Peer-to-Peer Electronic Cash System” at a cryptographic forum, which proposed the concept of bitcoin. As the value of bitcoin climbs, more and more people are starting to research the technology behind bitcoin the blockchain. Blockchain, also known as a distributed ledger technology, is an Internet database technology characterized by the decentralization, openness and transparency that allows everyone to participate in data logging, becoming one of the most popular research directions in finance. In the blockchain network, there is no core node. The functions and rights of all nodes are the same, and the consensus of all nodes is reached through a consensus algorithm to determine the next round of accountants.

In such a network, all nodes follow the established rules, and all results must be confirmed by most nodes. Each round of writing must be verified by most nodes in the network. Based on this technical idea, the blockchain is expected to be used to solve some existing problems in the existing network system, such as the network breakdown caused by the attack of a DNS server, the fraud caused by the tampering of the domain name resolution records, the tedious registration of the domain name and the uneven distribution of the root domain name nodes.

The domain name system (DNS) is a distributed database that maps to each other on the Internet as a domain name and an IP address. With the DNS, users can more easily access the Internet without having to remember IP addresses that can be read directly by the machine but are difficult to be understood and remembered by humans. Through the host name, the course of final acquirement of the corresponding IP address of the host name is called the domain name resolution. The DNS protocol is an application-layer protocol that runs on the UDP protocol using Port Number 53.

The general structure of the Internet host domain name is usually host name, third-level domain name, second-level domain name and top-level domain name. The Internet top-level domain name is registered and managed by the Internet Corporation for Assigned Names and Numbers (ICANN), an Internet association of domain name registration and query which is responsible for the Internet address assignment and also assigns a unique IP address to each host on the Internet.

The DNS domain name resolution has the following steps: in need of domain name resolution, the host first queries whether there is a corresponding local domain name information cache; the host will directly use the cache if it exists and query the local domain name server if it does not exist. The query of the host to the local domain name server is generally a recursive query, that is, if the local domain name server queried by the host does not know the IP address of the domain name queried, the local domain name server, as a DNS client, will continue to issue a query request message to other root name servers, rather than allow the host itself to do the next query. The query of the local domain name server to the root name server is usually an iterative query, which is characterized in that: when the root domain name server receives an iterative query request message from the local domain name server, it either gives the IP address to be queried, or tells the local domain name server “which domain name server should be queried next”, and then allows the local domain name server to do the subsequent query. The local domain name server returns the resolved IP address to the host initiating the query through the iterative query. It is certain that the local domain name server can also use the recursive query, which depends on the set query mode of the initial query request message.

The existing DNS has the following problems:

1. over-centralization of the domain name management: in the existing DNS, the generation and assignment of a top-level domain name completely depends on ICANN, lacking a fair competition mechanism; meanwhile, the domain name transaction and change procedures are cumbersome, which leads to an inefficient management of domain names.

2. Security issue: the DNS is a layered and centralized system, which makes the existing DNS often face the DDoS attacks in actual operation, causing the network to be paralyzed; the system is poor in robustness and cannot provide a stable domain name resolution service to the outside; in recent years, attacks on a single DNS server node have caused frequent network paralysis.

3. Imbalanced distribution of the root node servers: currently there are 13 root node servers worldwide, wherein 10 are in the United States, 2 are in Europe and 1 is in Japan, showing a seriously imbalanced distribution, which also leads to an inefficient resolution of the system.

4. The fundamental control of the Internet belonging to a country causes other countries to have inherent inequalities in Internet sovereignty and rights; the security of Internet cannot be guaranteed in most countries.

A Blockchain startup based in San Francisco built a new blockchain-based naming and storage system called Blockstack. Blockstack is an open-source naming system that runs on the bitcoin blockchain.

The architecture of the Blockstack system consists of four layers, namely, from the bottom up in order, a blockchain layer, a virtual chain layer, a routing layer and a storage layer, wherein the blockchain layer and the virtual chain layer are called “control layer”, with the remaining two layers called “data layer”. The blockchain layer runs an actual public chain, and Blockstack currently uses the bitcoin as its blockchain layer. The virtual chain layer defines its own protocol at the blockchain level and is a transaction record that can be perceived by the system software itself. The routing layer is responsible for binding the name defined by the control layer to the corresponding data file. The data layer is made up of the public cloud selected by the user; through the routing layer, the extra large data bound by the name data pair can be resolved. Blockstack decouples the control part from the data part through a layered approach. On one hand, this method separates the layers, that is, the change of a layer does not affect the normal operation of other layers; on the other hand, the amount of transmitted data at the control layer is reduced, which alleviates the pressure on the capacity of the underlying blockchain data and stores the data in the point-to-point distributed network used at the routing layer and a public cloud used at a data layer.

The main advantages of Blockstack are as follows: first, a four-layer architecture of the system is proposed to separate the control layer from the data layer; second, a global naming system is constructed based on the Namecoin operation; third, a concept of virtual chain is proposed that the consistently hashed simplified name verification protocol accelerates the node validation and new node joins.

The shortcomings of Blockstack are as follows:

1 unsolved problem of the top-level domain name assignment: Blockstack is a universal completely-decentralized naming system, rather than a complete domain name resolution system, and the DNS is only a special case of Blockstack; therefore, the issue of the top-level domain name assignment is not discussed in the design of Blockstack, thus leading to the proliferation of the top-level domain names registered in Blockstack.

2. To-be-verified efficiency of resolution: Blockstack does not have a variety of cache structures just like the existing DNS; when the amount of resolved data is large enough, the efficiency of resolution needs to be verified.

3. Heavy dependence on the bitcoin chain: Blockstack runs on bitcoin blockchain, writing the pointer of a resolved record in a free field on the bitcoin chain; if other applications also write the record in the field of the bitcoin chain or the adjustment of the bitcoin chain occupies the field, the Blockstack will not run properly.

4. Compatibility with the DNS: Blockstack, as a name resolution system, can only do one-to-one correspondence for the names and addresses of objects, but cannot point the resolution for the existing domain name resolution system; Blockstack has a competing and mutually exclusive relationship with the existing domain name resolution system in terms of the existence.

### BRIEF SUMMARY OF THE INVENTION

The objective of the invention is to provide a blockchain-based domain name resolution system that aims to solve the above technical problems.

The invention is implemented as follows: a blockchain-based domain name resolution system, characterized in that the domain name resolution system adopts a layered structure comprising a top-level domain name chain network, a second-level domain name chain network, a future network node and an existing DNS system network; the top-level domain name chain network links the second-level domain name chain network, the future network node and the existing DNS system network respectively, and the top-level domain name chain network is used for each professional organization to deploy the server nodes having a reliable performance respectively to form a union blockchain network, wherein each node server records the information of all the current top-level domain name chain nodes, the second-level domain name chain master nodes, the future network nodes and the root nodes of the existing DNS system; the second-level domain name chain network is used for the registration and management of domain names, and recording of all the second-level domain names and their subdomain names; the future network node is used for the storage of the metadata and index in the future network.

A further technical solution of the invention is as follows: all nodes in the top-level domain name chain network use a negotiation mechanism to jointly maintain the records of additions and changes of a top-level domain name or a future network node, and meanwhile, use the blocks to record the information of each second-level domain name chain and the future network node server.

A further technical solution of the invention is as follows: the top-level domain name chain network allows an ISP or a large-scale local area network to deploy a dedicated server as a resolving cache server.

A further technical solution of the invention is as follows: the top-level domain name chain network ensures that only a block created by one node in each round passes the verification through a consensus algorithm.

A further technical solution of the invention is as follows: the information recorded by the top-level domain name chain network comprises the information of master nodes of the second-level domain name chain, nodes of the future network, root nodes of the existing DNS system, and stored nodes of other domain names or objects.

A further technical solution of the invention is as follows: the second-level domain name chain network has a plurality of nodes distributed in different locations so that resolving applicants in different regions have quick access.

A further technical solution of the invention is as follows: a large number of the cache servers in the entire domain name resolution system access the top-level domain name chain network, and the cache servers synchronize the registration records of all the top-level domain name chains in real time.

A further technical solution of the invention is as follows: the cache server does not directly update the domain name resolution record to the second-level domain name chain.

A further technical solution of the invention is as follows: when the synchronization process is not completed after the cache server accesses the top-level domain name chain network, the cache server needs to obtain a resolution record from the top-level domain name chain network.

The beneficial effects of the invention are as follows: the right of domain name development is handed over to the Internet participants all over the world and no longer monopolized by an independent institution, which improves the management efficiency of the domain names; the domain name resolution service is no longer controlled by 13 specific servers and their attached mirrored servers, but will be provided by the blockchain network nodes and the cache servers distributed all over the world, which greatly improves the resolution efficiency and meanwhile solves the problem of uneven distribution of DNS servers; moreover, the addition of blockchain network nodes and cache servers can quickly expand the domain name resolution network; the domain name is managed by different professional organizations, with an introduced competition mechanism, which makes the management of domain names more efficient and the registration cost lower; with the distributed ledger technology, the registration information of domain names is kept in the ledger of each node, so that in case someone wants to attack the server, in theory, more than half of the server nodes must be controlled, so this architecture effectively guarantees the security of the domain name resolution system; by using the distributed ledger technology, each step of information registration will be completely preserved, which allows an effective retrospect to malicious acts; the invention supports the resolution of the stored address of objects and the existing domain name system, without changing the architecture of the system.

### BRIEF DESCRIPTION OF THE SEVERAL VIEWS OF THE DRAWINGS

FIG. 1 is an overall architecture diagram of the blockchain-based domain name resolution system provided in an embodiment of the invention; and

FIG. 2 is a schematic diagram of the process of domain name resolution provided in an embodiment of the invention.

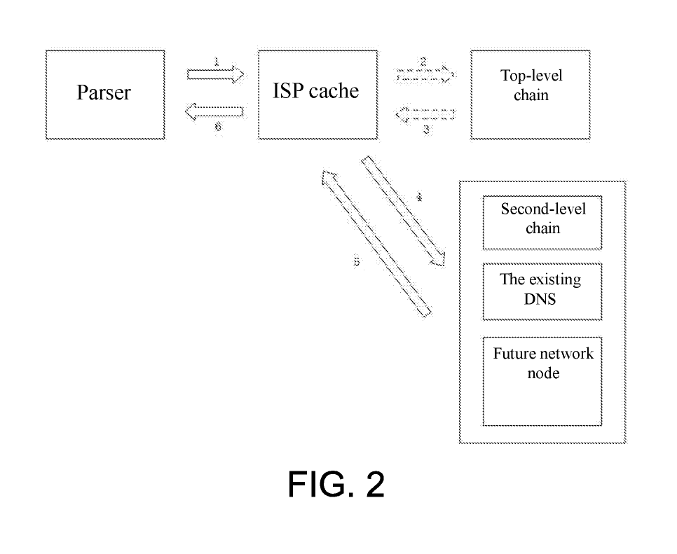

### DETAILED DESCRIPTION OF THE INVENTION

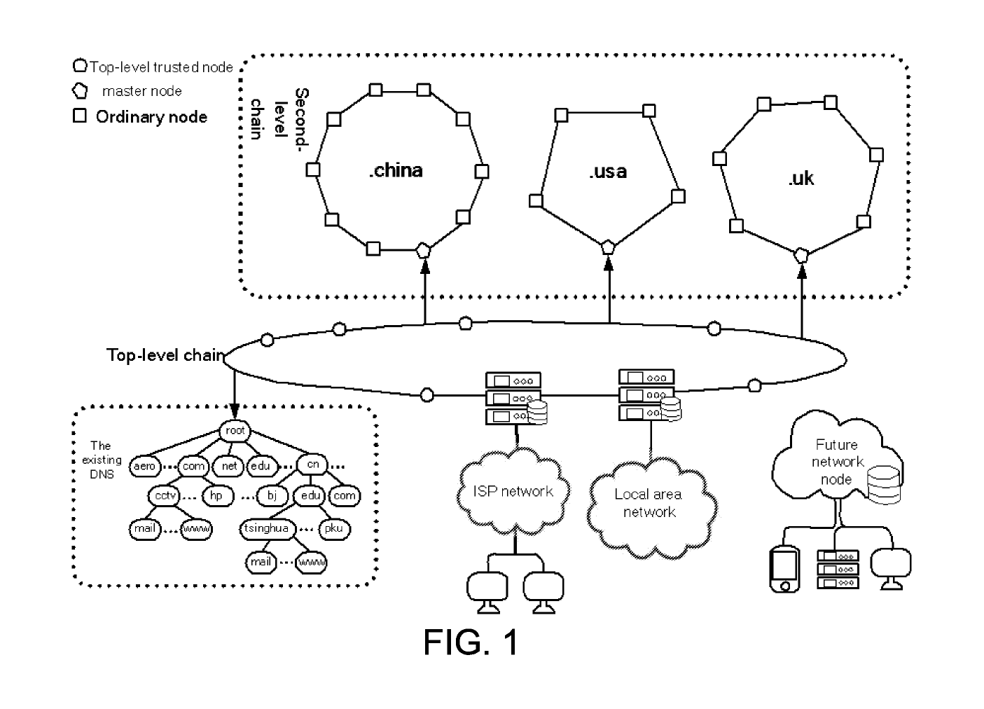

FIG. 1 shows a blockchain-based domain name resolution system provided in the invention, characterized in that the domain name resolution system adopts a layered structure comprising a top-level domain name chain network, a second-level domain name chain network, a future network node and an existing DNS system network; the top-level domain name chain network links the second-level domain name chain network, the future network node and the existing DNS system network respectively, and the top-level domain name chain network is used for each professional organization to deploy the server nodes having a reliable performance respectively to form a union blockchain network, wherein each node server records the information of all the current top-level domain name chains, the second-level domain name chain master nodes, the future network nodes and the root nodes of the existing DNS system; the second-level domain name chain network is used for the registration and management of domain names, and recording of all the second-level domain names and their subdomain names; the future network node is used for the storage of the metadata and index in the future network.

A blockchain network based on a distributed ledger technology is used; the network adopts a layered structure consisting of a top-level domain name chain network and a second-level domain name chain network, wherein, the top-level domain names are jointly maintained by the countries (regions) all over the world or the legal professional organizations (hereinafter referred to as “professional organizations”) in the industry. Each professional organization deploys the server nodes having a reliable performance respectively to form a union blockchain network, wherein each node server records the information of all the current top-level domain name chain nodes, the second-level domain name chain master nodes, the future network nodes and the root nodes of the existing DNS system; the second-level domain name chain network nodes are used for recording of all the second-level domain names and their subdomain names.

The top-level domain name chain network links the following networks: (1) the second-level domain name chain, which is created, managed and maintained by an organization that manages the trusted nodes in the top-level domain name chain; the chain is mainly used for the registration and management of domain names; (2) the future network node, which stores the metadata and index in the future network; (3) the current domain name resolution system.

Mainly aimed at the problems of poor scalability, uneven distribution, low system security and centralized distribution of top-level domain names in the existing domain name resolution system, the blockchain-based domain name resolution system provides a distributed ledger technology which solves the entire Internet access risk caused by the security issue of the domain name resolution server, which improves the scalability performance of the domain name resolution system, and meanwhile, greatly improves the performance of the domain name resolution system and reduces the cost of system management.

The system based on the distributed ledger technology meets the following three characteristics: (1) the newly-added top-level domain names are no longer managed by a single organization and can be jointly negotiated and managed by unions all over the world. (2) The domain name resolution is no longer controlled by 13 root servers and their mirrored servers all over the world, and can be provided by parallel node servers distributed on all continents; moreover, the regulatory organizations in various countries and regions can deploy the service nodes as needed. (3) The end user does not need to know the location of the domain name server or the future network node server; the entire analysis system is completely transparent to the user. Such attributes improve the overall security and resolution efficiency of the DNS and reduce the cost of system management. (4) It shows that all sovereign states have the true governance sovereignty over their cyberspace.

All nodes in the top-level domain name chain network use a negotiation mechanism to jointly maintain the records of additions and changes of a top-level domain name or stored nodes of objects, and meanwhile, use the blocks to record the information of each second-level domain name chain and the object storage server.

The professional organizations of domain name management all over the world each deploy the node servers of the top-level domain name network, and such profession organizations for a union to jointly maintain the top-level domain name chain network; all nodes use a negotiation mechanism to jointly maintain the records of additions and changes of a top-level domain name or a future network node, and meanwhile, use the blocks to record the information of each second-level domain name chain and the future network node server.

The top-level domain name chain network allows an ISP or a large-scale local area network to deploy a dedicated server as a resolving cache server.

Because of the limited number of trusted nodes in the network, a user request for resolution may cause the server response to delay. To solve such a problem, the Internet service providers or large local area networks are allowed to deploy dedicated servers as resolution cache servers. After the cache nodes deployed by these organizations or individuals join the top-level domain name network, the information such as the top-level domain name and the location of future network nodes is obtained from the trusted nodes. These newly-added nodes cannot participate in the management of the top-level domain names, but only access to the latest analytical records as a mirrored server; if the nodes need to get involved in the management of blockchain network, they must submit an application to the blockchain network and be recognized by most trusted nodes. The cache server nodes do not participate in the daily management of blockchain network transactions and do not need to pass the credit certification, but are only responsible for downloading the latest domain name records and can join or leave the top-level domain name chain network at any time.

The top-level domain name chain network ensures that only a block created by one node in each round passes the verification through a consensus algorithm.

The accounting right of the top-level domain name chain network is implemented by using a consensus mechanism. Each round of accounting process calculates the next round of accounting nodes through a consensus algorithm, and the records of changed domain name nodes collected by the accounting nodes are written to the blocks and broadcast to the entire network. Other nodes carry on the consensus verification after receiving the broadcast. If the verification is passed, the block records are saved; if the verification fails, the block packet is discarded and the correct block packet is continuously waited until the verification is passed. Using this consensus algorithm ensures that the blocks created by only one node per round can pass the verification.

The information recorded by the top-level domain name chain network comprises the information of master nodes of the second-level domain name chain, nodes of the future network, root nodes of the existing DNS system, and stored nodes of other domain names or objects. The information recorded by the top-level domain name chain is as follows: (1) the information of master nodes of the second-level domain name chain; (2) the information of nodes of the future network; (3) the information of root nodes of the existing DNS system; (4) the information of stored nodes of other domain names or objects.

The second-level domain name chain network has a plurality of nodes distributed in different locations so that resolving applicants in different regions have quick access.

After obtaining new top-level domain names, the professional organizations of the domain name management all over the world can deploy their own second-level domain name chain networks. According to the management strategies of each professional organizations managing domain name, the network structure of the domain name chain can take many forms, such as a private chain, a public chain and a union chain, and the professional organizations of the domain name management can obtain the revenue through the registration fee of domain names.

A domain name applicant applies for a domain name to a professional organization to which the second-level domain name chain belongs, and the applied domain name will be stored in the header of a block. The subsequent transfer and update records will be recorded in the transaction information of a block in the form of records.

The second-level domain name chain network has a plurality of nodes distributed in different locations so that resolving applicants in different regions have quick access. In the second level domain name chain network, at least one node needs to be registered in the upper level domain name chain network, so that the upper level domain name chain can be directed to the current domain name chain network. The registration operation is carried out by a professional organization belonging to the second-level domain name chain network; when the records are written to the blocks of the top-level chain network, the records cannot be tampered with by hackers at will. If the registration of node information changes, the need to belong to the professional organizations to which the information belongs need to update the information in the top-level domain name chain network in time.

A large number of the cache servers in the entire domain name resolution system access the top-level domain name chain network, and the cache servers synchronize the registration records of all the top-level domain name chains in real time.

The cache server, as an important part of the entire domain name resolution network, is related to the running efficiency of the entire domain name resolution system. A large number of the cache servers in the entire domain name resolution network access the top-level domain name chain network, and such servers synchronize the registration records of all the top-level domain name chains in real time.

The cache server does not directly update the domain name resolution record to the second-level domain name chain.

The cache server does not directly update the domain name resolution record to the second-level domain name chain; when an end user submits a domain name resolution request to the cache server, the cache server searches for the resolution record in its own cache list and returns the result if the record exists. If no search records are found, a resolution request is sent to the corresponding second-level domain name chain (or other domain names and future network node servers); the second-level domain name chain searches for the record and return the result to the cache server. After the cache server returns the result to the end user, the result is stored in the cache list for use in the next resolution.

When the synchronization process is not completed after the cache server accesses the top-level domain name chain network, the cache server needs to obtain a resolution record from the top-level domain name chain network.

In principle, the cache server does not directly obtain the resolution records from the top-level network; however, when the synchronization process is not completed yet after the cache server accesses the top-level network, the cache server needs to obtain the resolution records from the top-level network.

The query process of the future network node and the existing domain name resolution system is the same as that of the second-level domain name chain.

Because the cache server does not need to submit an authentication request to the top-level chain name network, there is no additional burden on the top-level chain name network. The cache server is the main entrance of the domain name resolution network; an end user accessing the cache server can directly obtain the domain name resolution records from the cache server, which reduces a large number of resolution requests of the top-level domain name chain and the second-level domain name chain network, thus effectively improving the efficiency of domain name resolution.

The application of the distributed ledger technology in the domain name resolution system solves the main problems in the existing domain name resolution system: (1) the right of domain name development is handed over to the Internet participants all over the world and no longer monopolized by an independent institution, which improves the management efficiency of the domain names; (2) the domain name resolution service is no longer controlled by 13 specific servers and their attached mirrored servers, but will be provided by the blockchain network nodes and the cache servers distributed all over the world, which greatly improves the resolution efficiency and meanwhile solves the problem of uneven distribution of DNS servers; moreover, the addition of blockchain network nodes and cache servers can quickly expand the domain name resolution network; (3) the domain name is managed by different professional organizations, with an introduced competition mechanism, which makes the management of domain names more efficient and the registration cost lower; (4) with the distributed ledger technology, the registration information of domain names is kept in the ledger of each node, so that in case someone wants to attack the server, in theory, more than half of the server nodes must be controlled, so this architecture effectively guarantees the security of the domain name resolution system; (5) by using the distributed ledger technology, each step of information registration will be completely preserved, which allows an effective retrospect to malicious acts; (6) the invention supports the resolution of the stored address of objects and the existing domain name system, without changing the architecture of the system.

The foregoing are only used as preferred embodiments of the invention and are not intended to limit the invention, and any modifications, equivalent substitutions and improvements based on the spirit and principle of the invention shall be covered in the protection scope of the invention.

1. A blockchain-based domain name resolution system, wherein the domain name resolution system adopts a layered structure comprising a top-level domain name chain network, a second-level domain name chain network, a future network node and an existing DNS system network; the top-level domain name chain network links the second-level domain name chain network, the future network node and the existing DNS system network respectively, and each professional organization deploys the server nodes having a reliable performance respectively to form a union blockchain network, wherein each node server records the information of all the current top-level domain names, the second-level domain name chain nodes, the future network nodes and the root nodes of the existing DNS system; the second-level domain name chain network is used for the registration and management of domain names, and recording of all the second-level domain names and their subdomain names; the future network node is used for the storage of the metadata and index in the future network.

2. The domain name resolution system as claimed in claim 1, wherein all nodes in the top-level domain name chain network use a negotiation mechanism to jointly maintain the records of additions and changes of a top-level domain name or a future network node, and meanwhile, use the blocks to record the information of each second-level domain name chain and the future network node server.

3. The domain name resolution system as claimed in claim 2, wherein the top-level domain name chain network allows an ISP or a large-scale local area network to deploy a dedicated server as a resolving cache server.

4. The domain name resolution system as claimed in claim 3, wherein the top-level domain name chain network ensures that only a block created by one node in each round passes the verification through a consensus algorithm.

5. The domain name resolution system as claimed in claim 4, wherein the information recorded by the top-level domain name chain network comprises the information of master nodes of the second-level domain name chain, nodes of the future network, root nodes of the existing DNS system, and stored nodes of other domain names or objects.

6. The domain name resolution system as claimed in claim 5, wherein the second-level domain name chain network has a plurality of nodes distributed in different locations so that resolving applicants in different regions have quick access.

7. The domain name resolution system as claimed in claim 6, wherein a large number of the cache servers in the entire domain name resolution system access the top-level domain name chain network, and the cache servers synchronize the registration records of all the top-level domain name chains in real time.

8. The domain name resolution system as claimed in claim 7, wherein the cache server does not directly update the domain name resolution record to the second-level domain name chain.

9. The domain name resolution system as claimed in claim 8, wherein when the synchronization process is not completed after the cache server accesses the top-level domain name chain network, the cache server needs to obtain a resolution record from the top-level domain name chain network.
